(19) United States
(12) Patent Application Publication
(10) Pub. No.: US 2002/0035755 A1
(43) Pub. Date: Mar. 28, 2002

(54) Interactive leather for gloves, shoes, garments and upholstery

(76) Inventor: John D. Widdemer, Gloversville, NY (US)

Correspondence Address: AUFRICHTIG STEIN & AUFRICHTIG, P.C., FIFTH FLOOR, 300 EAST 42ND STREET, NEW YORK, NY, 10017, US

(21) Appl. No.: 09/880,691

(22) Filed: Jun. 13, 2001

Related U.S. Application Data
(60) Provisional application No. 60/211,422, filed on Jun. 14, 2000.

(51) Int. Cl. C14C 1/00; C14C 3/00; C14C 5/00; C14C 11/00

(52) U.S. Cl. 8/94.15; 8/94.19 R; 8/94.2

(57) ABSTRACT

A leather made beneficially interactive with the human body through the insertion of rare earth elements and/or ceramics into its fiber matrix for use in garments, footwear, gloves or upholstery. A tanned leather having an internal fiber matrix has fine particles of rare earth elements and/or ceramics trapped and imbedded into the internal fiber matrix of the leather in sufficient amount to reflect and amplify infrared radiation. The trapped particles receive short wave infrared radiation from a human body and from the surrounding environment and reflect and amply them and convert the short wavelength infrared radiation into long wavelength infrared radiation that penetrates more deeply into human flesh with the beneficial results of increased blood flow, cellular activity and healing. In addition, a layer of phase change materials can be added to the surface of the leather to provide a temperature stabilizing material.

### BACKGROUND OF THE INVENTION

The invention is generally directed to leather and leather products containing ingredients that interact with the human body to provide the benefits of comfort, pain relief and performance through increasing blood flow and providing warmth, internally and externally. In particular, the invention is directed to specific methods for the production of leather containing such ingredients and to interactive leather and leather products such as gloves, shoes, garments and upholstery.

It is known that certain rare earth elements and ceramics reflect and amplify radiation such as laser beams and other wavelengths of light. It has also been known that certain rare earth elements and ceramics reflect, amplify and can change the wavelengths of radiation such as laser beams and other wavelengths of light. The fiber optics industry and Corning Glass Company as an example, has developed methods of sending information by laser impulses over glass fiber optic cables long distances by incorporating the rare earth element erbium in amplification stations along the cable. At each station the laser beam is excited and amplified up to 10,000 times. Without such amplification, the laser beams would be absorbed gradually by the glass fiber and weaken to a state of ineffectiveness where the signal would not be detectable. Similar rare earth elements (such as neodymium, titanium and many others) and powdered ceramics have an amplification effect on the far infrared radiation emitted by the human body and present in the background radiation of the earth's environment. When in proximity to the human body these elements and ceramics amplify, reflect and change the infrared radiation from short to long wave radiation so that it penetrates deeply into the body, stimulating the water molecules that make up most of the content of human cells. This creates an inner warmth and concurrently an increased blood flow. The phenomenon is called “electromagnetic resonance”. Tests run by Holofiber Enterprises, Inc. of 8950 West Olympic Blvd., Beverly Hills, Calif. 90211, demonstrate with Photopletysmography and by Laser Doppler methods acceleration of blood flow to 15 cm/sec from 11 cm/sec., without raising blood pressure, by application of a complex of reflective ceramics in a textile wrap applied to the subjects' elbows. Similarly, gripping strength was increased by 7% in subjects wearing textile gloves containing these complex ceramics. Zer Corporation of 403 Ace Techno Tower, 684-1, Deungchon-Dong, Kangseo-Gu, Seoul, South Korea, has demonstrated similar results through Kerlian photography and thermal imaging, using rare earth elements such as erbium, neodymium and titanium. The effects of this increased blood flow are to increase nourishment of human cells promoting healing, warming bodily extremities, providing more oxygen for energy to muscles and generally promoting well being.

Until now, these materials have only been able to be utilized in fragile materials like textiles, where they are coated on the fibers or in stiff plastics or embedded in building materials such as concrete. These applications are not suitable for uses requiring durable and flexible sheathings such as work gloves, sports gloves, shoes, outerwear or automotive or home upholstery. Therefore, a need exists for a method of permanently inserting ceramics or rare earth elements into leathers which can be worn comfortably next to the skin (as gloves, shoes or garments) or be in near proximity to the skin such as in the case of auto or home furniture upholstery. Benefits to the wearer or user would include strong grip for golfers, baseball players, racquet sports players, carpenters, and others engaged in activities requiring strong grip and a general physical performance enhancement, as well as pain reduction and speeded healing in areas affected by injuries or maladies such as “tendinitis”, arthritis and other muscular, bone and joint ailments.

In certain conditions (for instance extremely cold or hot weather) it would be advantageous to enhance the comfort effect of interactive ceramics and rare earth elements with the addition to leathers of phase change materials. There are many phase change materials (water being an example in changing to steam at high temperature and to ice at low temperature). In this example, water can be purposely changed to ice and then used for cooling as it changes back to water in a warm environment. There are other phase change materials that can be programmed to change in a narrow temperature range and one example is encapsulated octadecane (an isometric liquid hydrocarbon) produced by 3M Company. These “phase change capsules”, about 40 microns in size, when inserted permanently into leather and worn as gloves, shoes or garments can help to maintain body temperature in a predetermined comfortable temperature range. To achieve effective phase change results in leather, it is necessary to embed in the leather between 10% and 30%, and more preferably, 15% and 20% of intact capsules by weight of the leather, which would achieve a warmth effect of about 1.2 btu per square foot. The octadecane phase change capsules are easily degraded by exposure to a pH below a range of about 4.5 to 5.0 and more preferably, below about 4.8. The octadecane phase change capsules are also easily degraded by rough mechanical action and by temperatures above 300 degrees F. Traditional leather processing uses pH levels as high as 6.8, but generally less than 4.5, very high temperatures and heavy mechanical drumming, staking and shaving procedures would destroy up to about 90% of the fragile inserted phase change capsules. Previous attempts to add phase change capsules have used these traditional tanning methods, as for example, in U.S. Pat. No. 6,179,879. In that patent, a process is used where the capsules are added to the inner structure of the leather through drumming with a fat liquor solution and much of the liquid carrying expensive capsules is lost in the draining process. Accordingly, there is a need for a leather process that avoids damaging aspects of inserting phase change capsules by traditional tanning methods and also successfully inserts ceramic particles or rare earth elements into leather, creating a leather interactive with and beneficial to the human body.

### SUMMARY OF THE INVENTION

The invention is generally directed to leather and leather products impregnated with rare earth elements and/or ceramics that amplify, modify and return infrared radiation emitted by the human body deep into human flesh, increasing blood flow and stimulating cellular activity in promoting healing and general well being.

The invention is also generally directed to leather and leather products with thin layers containing phase change materials adhered to its outer surfaces, the leather becoming interactive with the human body, absorbing heat from the body and returning it when temperatures drop, hereby providing surface warmth and temperature modulation, resulting in enhanced physical performance and comfort.

The invention is also generally directed to the method of impregnating leather and leather products with rare earth elements and/or ceramics without damaging or reducing the effectiveness of those materials, into the leather.

Another object of the invention is to provide leather products, including gloves, garments shoes and upholstery containing rare elements and/or ceramics in the leather fiber matrix.

Yet another object of the invention is to provide leather products including gloves, garments, shoes and upholstery surfaced with thin layers containing phase change materials.

Still other objects and advantages of the invention will, in part, be obvious and will, in part, be apparent from the specification.

The invention accordingly comprises the features of construction, combination of elements, arrangement of parts, combinations of steps and procedures, all of which will be exemplified in the constructions and processes hereinafter set forth and the scope of the invention will be indicated in the claims.

### DETAILED DESCRIPTION OF THE PREFERRED EMBODIMENTS

In accordance with the invention, applicant has developed a basic procedure for taking skins from their pickled state to the wetblue state, and then from the wetblue state to the glove leather states. The procedure for taking skins from their pickled state to a wetblue state is well known in the art and different procedures known in the art are utilized depending upon the ultimate use of the leather. Different procedures would, for example, be utilized in connection with leathers to be used for gloves, shoes and upholstery. After processing the skins to the wetblue state they are then shaved to the desired weight or thickness.

Table 1 below, entitled “Shaved Wetblue to Interactive Leather Glove (with Rare Earth Minerals and/or Ceramics)” identifies a process for re-tanning the wetblue leather to a glove leather condition suitable for the addition of the rare earth elements and ceramics. At this stage the percentages shown in the table are based on 60% of the pickled weight of the original skins. This is traditional in the industry as the initial tanning process, going from the pickled to the wetblue states, tends to reduce the weight of the skins by about 40%.

TABLE 1
SHAVED WETBLUE TO INTERACTIVE LEATHER
(with Rare Earth Minerals and/or Ceramics)
Based on 60% of Pickle Weight

| Step | Percentages and Materials | | Time | Notes |
|---|---|---|---|---|
| 1 | | 200% WATER | 30 Minutes | pH 3.6 |
| | | 0.20% DEGREASING AGENT | | Drain |
| | | [Fatty Alcohol Ethoxylate] | | |
| | | 0.20% FORMIC ACID | | |
| 2 | a) | 200% WATER | 20 Minutes | |
| | | 4.0% ALDEHYDE TANNING AGENT | | |
| | | [Aliphatic Aldehyde] | | |
| | b) | 5% TO 12% RARE EARTH MINERALS | 20 Minutes | |
| | | AND/OR CERAMIC POWDER | | |
| | c) | 1.0% SYNTHETIC FAT | 10 Minutes | |
| | | [Synthetic Oils] | | |
| 3 | a) | 0.5% CHROME POWDER | 30 Minutes | |
| | | 0.5% ALUMINUM TANNING AGENT | | |
| | | [Crystallized Aluminum Triformate] | | |
| | b) | 1.5% SODIUM FORMATE | 20 Minutes | pH 4.0 |
| | | | | Drain/Wash |
| 4 | | 100% WATER | 10 Minutes | |
| | | 1.5% SODIUM FORMATE | | |
| 5 | | 1.75% SODIUM BICARBONATE | 90 Minutes | pH 6.8 |
| | | 4.0% FILLING RESIN SYNTAN | | Drain/Wash |
| | | [Urea Condensation] | | |
| 6 | | 100% WATER @ 60° C. | 20 Minutes | |
| | | 3.0% ALDEHYDE TANNING AGENT | | |
| | | [Aliphatic Aldehyde] | | |
| 7 | a) | 18.0% HYDROPHOBING AGENT [Fatliquors] | 90 Minutes | |
| | | [Polymer Softeners with Anionic Esters] | | |
| | b) | 1.5% WHITE PIGMENT | 40 Minutes | |
| | c) | 2.0% FORMIC ACID | 2 × 10 Minutes | Drain/Wash |
| | | | +30 Minutes | |
| 8 | | 100% WATER @ 60° C. | 30 Minutes | |
| | | 0.75% HYDROPHOBING AGENT | | |
| | | [Fatliquors] | | |
| | | [Polymer Softeners with | | |
| | | Organo-Poly Siloxane] | | |
| 9 | | 1.0% FORMIC ACID | 2 × 10 Minutes | Check/Wash/Pile/ |
| | | | +30 Minutes | Samm/Set/Dry/Stake |

The Percentages of additives based on 60% of the weight of the pickled skins are shown in the second column. The third column indicates the number of minutes that the skins and additives are mixed and rotated in a revolving drum at each stage of the process. The right-hand column consists of notes related to the process including pH ranges and other instructions such as draining the liquid components.

As shown in Table 1, the shaved wetblue leather is drummed with 200% water, 0.2% Degreasing Agent [Fatty Alcohol Ethoxylate] and 0.2% Formic Acid for 30 minutes at a pH of 3.6. Thereafter it is drained.

Next, in Step 2 a) 200% water and 4% Aldeyde Tanning Agent [Aliphatic Aldehyde] are drummed for 20 minutes. Thereafter, in Step 2 b), between about 5% and 12% of Rare Earth Minerals and/or Ceramic Powder is added to the drum and drummed for an additional 20 minutes. The Rare Earth Minerals include those which reflect and amplify radiation and phase shift radiation, including reflective ceramics, rare earth elements such as Erbium, Neodimium, Titanium and others. Generally, the ceramics and rare earth elements are ground into powder so that they may be more easily applied to the leather. In a preferred embodiment between about 0.1%-12% of the rare earth minerals are trapped in the leather matrix. Next, in Step 2 c) 1% Synthetic Fat [Synthetic Oils] is added to the drum and drummed for an additional 10 minutes.

Next, in Step 3 a) 0.5% Chrome Power and 0.5% Aluminum Tanning Agent [Crystallized Aluminum Triformate] are added to the drum and drummed for an additional 30 minutes. In Step 3 b) 1.5% Sodium Formate is added to the drum to bring the pH to 4.0 and drummed an additional 20 minutes. Thereafter the contents of the drum are drained and washed. The wash consists of rinsing with water and allowing to drain. Generally, the drums include a section with a mesh portion which, if opened up, allows the liquid material in the drum to pour out the bottom of the drum but keep the skins contained in the drum.

In Step 4, 100% water and 1.5% Sodium Formate are added to the skins and drummed for 10 minutes. Next, in Step 5, 1.75% Sodium Bicarbonate and 4% Filling Resin Syntan [Urea Condensation] are added to the drum and drummed for 90 minutes at a pH of 6.8. Thereafter, the drum is drained and washed.

In Step 6, 100% of water is added to the drum at 60° Celsius, along with 3% of Aldeyde Tanning Agent [Aliphatic Aldehyde] which are drummed for 20 minutes.

Next, in Step 7 a), 18% of Hydrophobing Agent [Fatliquors] [Polymer Softeners with Anionic Esters] is added to the drum and drummed for a 90 minute period. Then in Step 7 b), 1.5% of white pigment is added and drummed for an additional 40 minutes. Thereafter, in Step 7 c), 2% of Formic Acid is added and drummed for 10 minutes, followed by an additional 2% of Formic Acid, which is then drummed for an additional 30 minutes. Thereafter, the drum is drained and washed.

Next, in Step 8, 100% of water is added at 60° Celsius, together with 0.75% Hydrophobing Agent [Fatliquors] [Polymer Softeners with Organo-Poly Siloxane] and drummed for 30 minutes. Finally, in Step 9, 1% of Formic Acid is added twice. First, 1% of Formic Acid is added and drummed for 10 minutes and then a second 1% of Formic Acid is added and drummed for an additional 30 minutes.

After all of these steps have been completed in the drum, the contents are drained, washed, the skins are piled and then squeezed dry in a Sammying process which is a press used in the industry for squeezing stacks of the skins which are piled between the jaws of the press to remove excess liquid. Finally, the skins are set, which is stretched to the desired size and shape, dried to fix the set shape and then staked by movement through a roller with dull metal blades which softens the dried leather.

This process produces a soft, synthetically re-tanned leather which includes rare earth minerals and ceramic powders which are useful in providing various benefits to the wearer of the glove, clothing, or shoe incorporating this interactive leather, or a person sitting on upholstery made from the interactive leather. The interactive leather includes within the fiber matrix of the interactive leather the rare earth minerals and/or ceramic powders selected for use. In current preferred embodiments of the invention selections of the various rare earth elements and ceramic powders incorporating rare earth elements and other materials which retain and then disburse energy in similar and frequency shifted ranges are utilized. The rare earth elements are reflective and absorbent. Some of these rare earth elements, as previously noted, have the ability to reflect and amplify infrared radiation, as well as to receive short wave infrared radiation from a human body and from the surrounding environment and reflect and amplify that short wave infrared radiation into long wavelength infrared radiation that penetrates deeper into human flesh with beneficial results, including increased blood flow, cellular activity and healing.

Following these steps, where the leather now contains the rare earth elements and ceramics trapped within its fiber matrix, a process of adding thin surface layers containing phase change materials can be undertaken. This process can also be used on leathers prepared by processes similar to the one described above but that do not contain rare earth elements and ceramics. The use of a liquid paraffin as a carrier of the PCM capsules enhances their effectiveness since paraffin is also a phase change material.

In a preferred embodiment of the invention a spray method for coating leather with phase change materials includes starting with one part (by weight) PCM capsules (to equal 3% to 20% of the finished weight of leather to be sprayed and more preferably 8% to 10%). To be added to one part (by weight) of liquid paraffin (KCF 661) and two parts (by weight) of water. These three elements are mixed for 10 minutes to form the spray coating for the leather. Then, the first spray coating is applied to the surface of the leather for one half of a minute and then allow to air dry for 90 minutes. Then, a second spray coating is applied for an additional half minute and again allowed to air dry for 90 minutes. Finally, the leather is then toggled, which means that it is stretched with mechanical toggle bolts in accordance with standard industry procedure for 20 minutes at 30° Celsius. This process allows the PCM capsules to be added to the leather without the destructive re-tanning chemicals and processes from degrading and destroying a substantial percentage of the PCM capsules. In this way, interactive leather including rare earth elements and/or ceramics and phase change materials provide an improved leather which provides substantial benefits to the user. For example, in a glove environment, the rare earth elements and ceramics incorporated into the matrix of the leather acts to convert the heat (short wave infrared radiation) given off by the wearer's hand to be reflected and radiated back into the user's hand at deeper levels as long wavelength (far infrared) infrared radiation which increases blood flow, cellular activity and healing. In addition, the surface layers of the phase change materials have the effect of providing overall cooling of the wearer's hand in warm environments and heating in cool environments. The rare earth elements and ceramics trapped within the fiber matrix only reflect back a percentage of the heat generated by the wearer's hand. Similarly, to the extent that energy is applied to the interactive leather gloves from the outside, some of the heat, in the form of the short wave infrared radiation, is absorbed by the ceramic and rare earth elements embedded in the matrix of the glove, and then radiated into the wearer's hand over time as frequency shifted long wavelength infrared radiation. In fact, when heat is applied to the interactive leather glove the rare earth and ceramic elements in the leather have the potential to act as a heat storage element which then, over time, will radiate the heat in the far infrared band into the wearer's hand.

Accordingly, an improved interactive leather is provided which includes rare earth elements and/or ceramic materials which beneficially interact with the human body through the insertion of rare earth elements and/or ceramics into its fiber matrix for use in garments, footwear, gloves or upholstery. The tanned leather has an internal fiber matrix in which fine particles of rare earth elements and/or ceramics are trapped and embedded in the internal fiber matrix of the leather in sufficient amount to reflect and amplify infrared radiation. The trapped particles receive short wave infrared radiation from a human body and from the surrounding environment and reflect and amplify them and convert the short wavelength infrared radiation to a long wavelength infrared radiation that penetrates deep into human flesh with beneficial results, including increasing blood flow, cellular activity and healing. Also, the invention is directed to a process for inserting the rare earth elements and/or ceramics into the fiber matrix of the leather, including converting pickled skins to a wetblue state and then converting wetblue skins to leather suitable to receive rare earth minerals and/or ceramic powder and adding rare earth minerals and/or ceramic powder to the materials and trapping them in the fiber matrix of the leather.

It will thus be seen that the objects set forth above, among those made apparent in the proceeding description, are efficiently obtained and, since certain changes may be made in the above constructions and processes without departing from the spirit and scope of the invention, it is intended that all matter contained in the above description or shown in the accompanied drawings shall be interpreted as illustrative, and not in the limiting sense.

It will also be understood that the following Claims are intended to cover all of the generic and specific features of the invention, herein described and all statements of the scope of the invention which, as a matter of language, might be said to fall therebetween.

What is claimed is:

1. A tanned leather comprising:
an internal fiber matrix;
rare earth element and/or ceramic particles adapted to reflect, amplify and convert the wave lengths of infrared radiation incident upon the rare earth elements and/or ceramics, said rare earth element and/or ceramic particles being disposed and imbedded within the fiber matrix in a sufficient amount so that the rare earth elements and/or ceramics enhance the long wavelength infrared radiation of the leather when subjected to short wave infrared radiation from a human body or other source.

2. The leather of claim 1 wherein the rare earth elements and/or ceramics include one or more of Erbium, Neodymium and Titanium.

3. The leather of claim 1 wherein the amount of rare earth elements and/or ceramics in the leather is about 0.1% to 12% by weight.

4. The leather of claim 1 further comprising a layer of phase change material added to at least one surface of the leather to provide thermal stability to the leather.

5. A tanned leather for use in a garment, footwear, glove, upholstery or other leather product, comprising:
a tanned leather having an internal fiber matrix;
a rare earth and/or ceramic particles bonded to the tanned leather so that the rare earth element and/or ceramic powders penetrates the internal fiber matrix and are trapped within the internal fiber matrix; and
the trapped rare earth element and/or ceramic powders in the tanned leather beneficially interact with the heat generated by a human to reflect and amplify infrared radiation from a human source and convert the infrared radiation from the human or other source from its short wavelength infrared radiation to long wavelength infrared radiation that penetrates deeper into human flesh, whereby the tanned leather is particularly suitable for use in garments, gloves, footwear, upholstery and other leather products coming in contact with human users.

6. A glove comprising:
a tanned leather having an internal fiber matrix;
rare earth elements and/or ceramics adapted to reflect, amplify and convert the wave lengths of infrared radiation incident upon the rare earth elements and/or ceramics, said rare earth elements and/or ceramics being disposed and imbedded within the fiber matrix in a sufficient amount so that the rare earth elements and/or ceramics enhance the long wavelength infrared radiation of the leather when subject to short wave infrared radiation from a human body or other source.

7. The glove of claim 6 further comprising a phase changing material layer added on to at least one surface of the tanned leather so that the phase change material enhances the thermal stability of the leather when subject to heat or cold.

8. A garment comprising:
a tanned leather having an internal fiber matrix;
rare earth elements and/or ceramics adapted to reflect, amplify and convert the wave lengths of infrared radiation incident upon the rare earth elements and/or ceramics, said rare earth elements and/or ceramics being disposed and imbedded within the fiber matrix in a sufficient amount so that the rare earth elements and/or ceramics enhance the long wavelength infrared radiation of the leather when subject to short wave infrared radiation from a human body or other source.

9. The garment of claim 8 further comprising a phase changing material layer added on to at least one surface of the tanned leather so that the phase change material enhances the thermal stability of the leather when subject to heat or cold.

10. A shoe comprising:
a tanned leather having an internal fiber matrix;
rare earth elements and/or ceramics adapted to reflect, amplify and convert the wave lengths of infrared radiation incident upon the rare earth elements and/or ceramics, said rare earth elements and/or ceramics being disposed and imbedded within the fiber matrix in a sufficient amount so that the rare earth elements and/or ceramics enhance the long wavelength infrared radiation of the leather when subject to short wave infrared radiation from a human body or other source.

11. The shoe of claim 10 further comprising a phase changing material layer added on to at least one surface of the tanned leather so that the phase change material enhances the thermal stability of the leather when subject to heat or cold.

12. An upholstery covering comprising:
a tanned leather having an internal fiber matrix;
rare earth elements and/or ceramics adapted to reflect, amplify and convert the wave lengths of infrared radiation incident upon the rare earth elements and/or ceramics, said rare earth elements and/or ceramics being disposed and imbedded within the fiber matrix in a sufficient amount so that the rare earth elements and/or ceramics enhance the long wavelength infrared radiation of the leather when subject to short wave infrared radiation from a human body or other source.

13. The upholstery covering of claim 12 further comprising a phase changing material layer added on to at least one surface of the tanned leather so that the phase change material enhances the thermal stability of the leather when subject to heat or cold.

14. A process for inserting rare earth elements and/or ceramics into the fiber matrix of leather comprising:
converting pickled skins to wetblue state;
converting wetblue skins to leather suitable to receive rare earth minerals and/or ceramic powder;
adding rare earth minerals and/or ceramic powder; and
trapping the rare earth minerals and/or ceramic powder in the fiber matrix of the leather.

15. A beneficially interactive leather comprising:
a tanned leather and a surface coating of phase change materials which act as a temperature stabilizing material in a sufficient amount so that the phase change material enhances the thermal stability of the leather when subject to heat or cold.

16. The leather of claim 15 wherein the phase change material includes capsulated microspheres of the phase change material in a paraffin carrier.
